(19) United States
(12) Patent Application Publication
(10) Pub. No.: US 2002/0191673 A1
(43) Pub. Date: Dec. 19, 2002

(54) Temperature display equipped container clamp

(76) Inventor: Chih-Hsiung Lee, Pan-Chiao City (TW)

Correspondence Address: OSTROLENK FABER GERB & SOFFEN, 1180 AVENUE OF THE AMERICAS, NEW YORK, NY, 100368403

(21) Appl. No.: 09/882,980

(22) Filed: Jun. 15, 2001

(51) Int. Cl. G01K 1/14; G01K 13/00

(52) U.S. Cl. 374/141; 374/208

(57) ABSTRACT

A temperature display equipped container clamp is mainly composed of a clamp body and a temperature measurer mounted thereon, wherein the clamp body is made in form of a C-clamp for easy clamping on a cylindrical container, such as a bottle or a can. The temperature measurer further comprises: a temperature display panel embedded therein and driven by an inside circuit box; and a thermal sensing head disposed in the inner surface of the clamp body. When the clamp body is clamped on a cylindrical container, the thermal sensing head will be closely attached to the external wall of the container so that digits are shown in the display panel to tell the content's temperature.

### FIELD OF THE INVENTION

This invention relates to a temperature display equipped container clamp, which is implemented to clamp on the circumference of a bottle (or can) to show the temperature of inside beverage, liquor, etc.

### BACKGROUND OF THE INVENTION

Temperature is known one of several main factors that would affect taste of wine, for example, 12° C. and 18° C. are respective optimum temperatures suggested for storing or drinking the red wines, and it is the reason why a wine vault has to be air-conditioned.

Different temperature-controllers suitable for large-scale storage are available in the market for storing and aging wine until temperature balance is reached, however, such an equipment entails great expense that a consumer usually cannot afford, and besides, it doesn't show temperature data of each bottle for checking individual maturity.

It is nothing peculiar that people would like to take beverage of different temperature degrees according to personal habits and weather conditions. Everyone likes to have a cup of cooled drink in a sultry day, however, a touch or vision cannot tell coolness of the drink precisely to satisfactorily meet different favorites. Hence, it would be more convenient if a temperature display is available and mounted directly on a beverage bottle or can so that a customer can realize the beverage's temperature then and there.

### SUMMARY OF THE INVENTION

The primary object of this invention is to provide a temperature display equipped container clamp, which is clamped on the circumference of a container to show temperature of the inside content.

Another object of this invention is to provide a temperature display equipped container clamp, which is applicable to various cylindrical containers, such as bottles, cans, or cups for notice of content's temperature.

For more detailed information regarding advantages or features of this invention, at least an example of preferred embodiment will be elucidated below with reference to the annexed drawings.

### BRIEF DESCRIPTION OF THE DRAWINGS

The related drawings in connection with the detailed description of this invention, which is to be made later, are described briefly as follows, in which:

FIG. 1 is a schematic view of a temperature display equipped container clamp of this invention in three dimensions;

FIG. 2 is a rear view of the temperature display equipped container clamp of this invention; and

FIG. 3 is a cutaway sectional view of this invention.

### DETAILED DESCRIPTION OF THE INVENTION

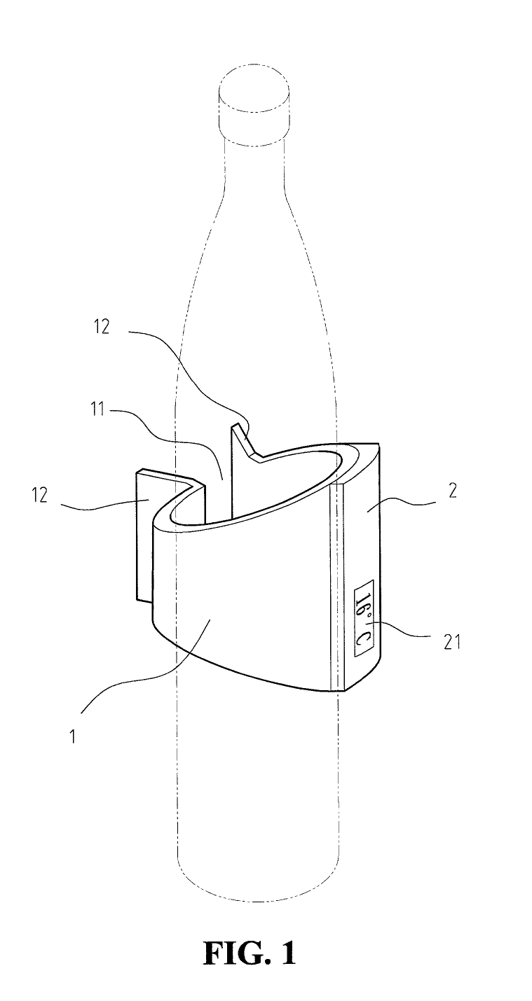

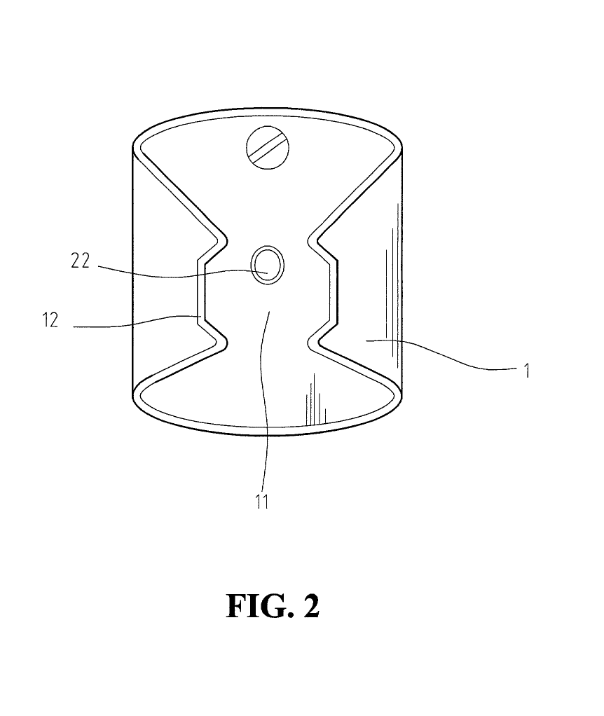

As illustrated in FIGS. 1 and 2, a temperature display equipped container clamp of this invention is composed of a clamp body 1 and a temperature measurer 2.

The clamp body 1 is constructed in form of a C-clamp having a gap 11 for clamping easily at a cylindrical bottle, can, or cup, wherein a protruding piece 12 is arranged at each of two lateral perpendicular ends of the clamp body 1 adjacent to the gap 11 and is extended outwardly and divergently to form a bell-like optimum contained angle to make it easy in clamping a cylindrical container. When drawing the clamp body 1 out of the cylindrical container is desired, this may be done by lifting the clamp body 1 directly upwards along longitudinal direction of the container or holding the clamp body 1 with palm and pulling the protruding piece 12 with fingers.

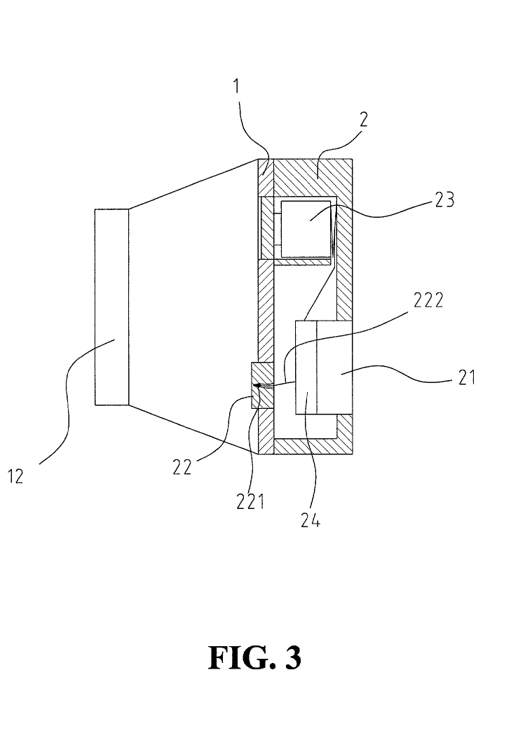

As shown in FIG. 3, the temperature measurer 2 is fitted on the back ridge of the clamp body 1 and composed of a temperature display panel 21, a thermal sensing head 22, a battery chamber 23, and a circuit box 24, wherein a thermistor 221 invested in a soft material is disposed in the thermal sensing head 22 and jointed with the circuit box 24 via a conductive wire 222; and the thermal sensing head 22 is protruded over the inner surface of the clamp body 1 so that it can contact the container surface closely to have its thermistor 221 sensed sharply and transmitted the impedance variation signals through the conductive wire 222 and the circuit box 24 for being quantified and displayed on the display panel 21 when the clamp body 1 is clamped on the cylindrical container.

The display panel 21 is embedded under the surface of the temperature measurer 2 at a proper position for easy viewing. The inside circuit box 24 is arranged for calculating the impedance variation of the thermistor 221 and driving the display panel to show the quantified temperature in form of digits. And, a battery disposed in the battery chamber 23 or a solar cell architecture is the power supply for the circuit box 24 and the display panel 21.

A user may aim the gap 11 of the clamp body 1 at a bottle (or can), then push the clamp body 1 forward to clamp on the external wall of the bottle so that he can read the display panel 21 of the temperature measurer 2 to make sure immediately if the temperature conditions of the beverage or wine is favorite.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A temperature display equipped container clamp, comprising:
an annular clamp body having a gap in its circumference; and
a temperature measurer disposed in the back ridge of the clamp body, further comprising:
an embedded temperature display panel driven by a circuit box located therein;
a thermal sensing head disposed in the inner surface of the clamp body, wherein a thermistor is connected to the circuit box via a conductive wire; and
a battery seat for accommodating a battery or battery pack to serve for a power supply.

2. The container clamp according to claim 1, wherein the clamp body is constructed in form of a C-clamp.

3. The container clamp according to claim 1, wherein a protruding piece is arranged at each of two lateral perpendicular ends of the clamp body adjacent to the gap and is extended outwardly and divergently to form a bell-like optimum contained angle.
